(19) United States
(12) Patent Application Publication
(10) Pub. No.: US 2003/0066370 A1
(43) Pub. Date: Apr. 10, 2003

(54) Device for the rotatable coupling of two coaxial connection elements

(76) Inventors: Erich Russ, Gremsdorf (DE); Dipl.-Ing. Werner Schroppel, Wendelstein (DE)

Correspondence Address: Pandiscio & Pandiscio, 470 Totten Pond Road, Waltham, MA, 02451-1914, US

(21) Appl. No.: 09/973,121

(22) Filed: Oct. 9, 2001

(51) Int. Cl. F16H 1/06

(52) U.S. Cl. 74/414; 74/813 R; 74/606 R

(57) ABSTRACT

The invention relates to a device for the rotatable coupling of two coaxial connection elements, comprising a rotating bearing between the connection elements for accommodating axial and radial loads and tilting moments, as well as a drive coupled to both connection elements to effect their relative rotation, the frame of the drive being secured to a first connection element, while its rotor meshes via a pinion or a worm with a casing-side toothing of the second connection element, comprising one or more housing parts enclosing the toothing of the second connection element in a dust-tight manner.

The present invention relates to a device for the rotatable coupling of two coaxial connection elements comprising a rotating bearing designed as a single-row or multi-row rolling bearing between the connection elements for accommodating axial and radial loads and tilting moments, as well as a drive coupled to both connection elements for their relative rotation, the frame of the drive being secured to a first connection element and its rotor being connected to a pinion or a worm, which pinion or worm meshes with a casing-side toothing of the second connection element, wherein securement elements arranged in the manner of a crown in or on a front end of the toothed connection element are provided for the securement of this connection element to a first bearing part, said securement elements being located between the toothing and the rotating bearing.

Such rotating connections are commercially available as so-called ball-bearing slewing rims. They are available in various diameters and overall heights (installed heights) so that the correct rotational connection can be chosen for each specific application. Preferred fields of use include building and construction machinery, for example diggers and excavators, as well as cranes, leaf flange bearings and tower structure bearings in large wind energy plants, conveying, lifting and loading/unloading devices, lifting platforms and scaffolding and vehicle cranes, heavy load transporters, ships' cranes, turntables for machine tools, rotating carousels, for example in bottling plants, medical apparatus, tail rotating collars for wood collecting machines, equipment for rides in amusement parks, etc. For many such applications it is important that the overall height of the rotatable connection be as low as possible, which is why the overall height of such ball-bearing slewing rings is in practice often scarcely greater than the height of the toothing of the connection part of the rotatable connection driven by a motor. Whereas the ball-bearing slewing rings are generally protected by rubber seals against dirt and contamination and thus against excessive wear and tear, corresponding safety measures are not adopted for the toothing, and accordingly foreign bodies can penetrate the latter during heavy-duty operation, for example on building sites, etc., which then reach the space between the toothing and the gear element, for example pinion or worm, meshing therewith and either become ground up or damage the tooth profiles. This latter danger arises in particular from hard materials such as stones or rock, or from hard metal turnings formed in machining tools. On account of the dirt particles penetrating the region of the toothing the lubricating grease also quickly becomes contaminated and therefore has to be replaced at short intervals. Finally, the unprotected toothing constitutes a potential source of injury, for example to the maintenance staff.

The present invention accordingly aims to obviate the disadvantages of the aforedescribed prior art and provide an improved rotating connection of the generic type described hereinbefore so that damage to the toothing region by penetrating foreign bodies is prevented as far as possible, the lubricating intervals of the toothing region are as long as possible, and the danger of injury is avoided as far as possible.

This problem is successfully solved with a generic device having a housing part surrounding at least the toothing of the second connection element, which housing part is secured to the untoothed connection element and encloses the toothed connection element on the front end opposite its connection/securement means, wherein the securement means for fastening the untoothed connection element to a second bearing part are arranged directly on the untoothed connection element so that the housing part according to the invention is for the most part not subjected to forces.

The invention utilises the fact that the two connection elements arranged coaxially in one another are usually mutually displaced by a small amount in the axial direction, the respective connection bores preferably being arranged in that front end of the connection elements which is displaced in the axial direction away from the other connection element. Since on the other hand the housing of the drive motor is connected to the untoothed connection element, which latter is therefore generally secured to the frame of the relevant machine, or to the stationary or larger machine part, the invention utilises the geometrical circumstances in an advantageous manner so as to secure the housing protecting the toothing to the untoothed connection part, despite the relatively close proximity to the toothed connection part, and thereby enclose the overall rotating part on two, preferably three sides of its cross-section and in this way exclude external influences as far as possible. The front end of the toothed connection element provided with the bores for the connection of a rotatable part is still externally accessible, but is however likewise covered by the installed housing. The housing according to the invention protects the toothed region from penetrating dirt particles and thus increases its service life; at the same time the lubricating grease is protected against impurities, with the result that the lubricating intervals can be extended, and finally protection against unintentional contact is afforded to the maintenance and repair staff. All this is achieved within the framework of an optimally designed structural arrangement, so that the user does not have to install an independent housing part and at the same time the construction of relatively large units is greatly simplified. Due to the fact that the securement elements of the untoothed connection part are arranged directly on the latter, the housing is largely free of torques and other forces and can therefore be designed having a relatively thin cross-section. In this way on the one hand the size of the structure, in particular overall height, can be minimised, and on the other hand savings in weight can be made.

It has proved convenient to produce the toothing and the guideway for the rolling bearing of the second connection element preferably by metal-removing machining, but also by a joint forming operation, for example by sintering, of the connection element/base member itself. In this way on the one hand the manufacturing process is simplified since the whole toothed connection element can be produced in one piece, and on the other hand the stability of the latter is improved and thus the transmissible axial and radial forces as well as tilting and drive moments can be increased. Furthermore, the securement bores of the second connection element can also be produced from the connection element/base member by metal-removing machining. In addition it is of course also possible for the toothing to be arranged on a separately manufactured structural part, which would then have to be connected to the relevant connection element in a second process step, for example by being pressed on, bolted on, etc.

It is possible within the framework of the invention for one or both connection elements to be formed as concentric rings or disks with securement elements, especially bores, arranged in the manner of a crown or collar. As a result of the large forces and moments that have to be transmitted, a large number of rolling elements is necessary, requiring a corresponding diameter of the rotating bearing. In order to save material a central recess may therefore be provided in one or both elements, through which non-rotatable parts, supply lines or the like may also be passed.

The securement bores may be formed as continuous recesses with or without internal threads, or as blind holes with internal threads. In the case of the toothed connection element surrounded on the front end by the housing part according to the invention, the invention recommends the use of bores having internal threads since the front end facing the connection surface is not accessible.

This feature of the invention can be developed further by designing the toothed connection element as an internally or externally toothed crown. In this embodiment with teeth of the connection element on the casing side, a maximum drive moment can always be transmitted irrespective of the angular setting of the toothed connection element, so that if necessary the overall height can be reduced to a minimum.

A further reduction in the overall height can be achieved if the rolling body/guideway of the toothed connection element is arranged on the casing surface facing its toothing. In this case almost the whole height of this connection element, predetermined by the height of the toothed region, is available to the rolling bearing.

Since the radial distance of the securement bores of the toothed connection element to the base of the rolling body/guideway of the toothed connection element roughly corresponds to the radial distance of these bores from the base of the toothing, an excessive, localised weakening of the toothed connection element can be avoided.

A further structural feature serves for the same purpose, according to which the securement bores of the toothed connection element are designed as blind holes open exclusively at its connection/front end, and whose axially parallel depth is between ½ and ¾ the overall height of the toothed connection element. This feature provides a further development, according to which the floor of the securement bores of the toothed connection element is situated at about the height of the greatest convexivity or tapering of the toothed connection element as a result of the incorporated guideway for the rolling bearing. In this way the rolling bearing guideway maintains a maximum distance from the securement bores, so that the radial extension of the toothed connection element and thus its weight can be reduced to a minimum without this connection element thereby being exposed to the danger of a deformation under the action of increased radial forces.

A further advantage of the feature of the present invention is that the housing part secured to the untoothed connection element extends in the form of an annulus along a front end of the toothed connection element and parallel to the latter. The dimensions of the annular housing part are in this connection largely predetermined by the dimensions of the connection elements, with the result that the radial extension of this annulus may be chosen for example be chosen to be only slightly larger than the corresponding dimension of the toothed connection element, so that the latter can just be enclosed, and the thickness of this housing part should be as small as possible, preferably equal to or less than the axial mismatch between the two connection elements, so that the housing part can be used without any increase in the overall height of the rotating connection, and depending on the specific embodiment may be radially outside or inside the untoothed connection element. In this connection the aim is to ensure that the untoothed connection element lies flush at the front end against the housing part secured thereto, or slightly raised with respect to the latter. Preferably in such a case the overall height of the structural group comprising the rotating connection corresponds, possibly with the exception of a peripherally arranged drive structural group, to the distance between the two connection surfaces of the connection elements. If for other reasons the overall height of the rotating connection is of minor importance, this annulus may also be securely bolted or otherwise suitably fastened, for example welded, bonded, pressed on, riveted, etc., to a front end of the untoothed connection element, resulting in a slight increase in the overall height. A roughly cylindrical housing part in the form of a casing then adjoins this annular housing part on the periphery facing the untoothed connection element, which cylindrical housing part extends over the whole toothing as far as the opposite front end of the toothed connection element. This cylindrical housing part in the form of a casing is preferably connected, for example welded, to the annular housing part, or may be manufactured in one piece with the latter.

Provided that—as the invention furthermore envisages—the housing part according to the invention is detachably secured to the untoothed connection element, it can be removed for the purposes of maintenance of the rotating connection according to the invention.

The detachable connection may be realised with very little effort, by firmly bolting the housing part to the untoothed connection element. If the thickness of the housing part so allows, a stepped recess may be provided in the latter through which corresponding machinery bolts may pass, until their heads emerge completely in the radially widened region created by the stepped arrangement, so that the overall height of the arrangement is not increased further by such a bolt connection.

In this way it is possible to screw securement bolts, designed as machinery bolts, into threaded bores of the untoothed connection element parallel to the axis of rotation. The arrangement may in this connection be implemented so that these bolts joining the housing to the untoothed connection element are, when incorporated into a machine, covered by its frame or its stationary part so that an accidental disengagement of the housing part according to the invention is prevented. The invention permits a development in which the housing part is centred on the untoothed connection part by means of a channel provided on the connection element or the housing part. In this way a separate adjustment can on the one hand be avoided, and in addition an undesired displacement of the housing part with respect to the untoothed connection element is completely impossible even if one or more of the securement bolts should work loose.

If the channel serving for the centering is provided on the edge of the untoothed connection element facing the housing part, the annular housing part may be inserted therein. For this purpose the depth of the channel should be somewhat smaller than the axial mismatch of the untoothed connection element with respect to the toothed element, so that the annulus sitting on the floor of the channel does not contact the toothed connection element.

In order to be able to secure the housing/annulus immovably to the untoothed housing part also in the axial direction, the machinery bolts must engage at least a part of the annulus in order to be able to press the underside of the latter firmly against the floor of the channel. This may be achieved according to the invention by providing one or more sunk cavities on the outside of the annular housing part, at least one machinery bolt being associated with each of the sunk cavities for the purposes of securement to the untoothed connection element. These sunk cavities may engage from behind, underneath the bolt heads or by means of bodies, e.g. washers, secured by the latter, and in this way the relevant housing part can be pressed firmly against the channel of the untoothed connection element, while at the same time the heads of the machinery bolts used for the securement are concealed in the respective sunk cavity.

This embodiment can be developed further by extending the sunk cavities of the housing/annulus as far as the casing surface of the housing part facing the untoothed connection element and can be continued by a sunk cavity, corresponding as regards depth and cross-section, of the untoothed connection element. This inventive feature develops the concept of forming a depression space common to the annular housing part and the untoothed connection element so that the head of the securement bolt or a securement element engaged from behind by the latter can be inserted into the common recess so as to cover the joining site between the untoothed connection element and the housing part to be attached thereto. In such an arrangement the task of bolting the securement bolt into the untoothed connection element can be realised in a simple manner and at the same time the housing part located mainly laterally outside the latter can be enclosed and fixed.

The first part of this combined objective is achieved by providing in the floor of the sunk cavities in the untoothed connection element at least one threaded bore parallel to the axis of rotation for each of the machinery bolts. Although the housing part to be secured lies largely outside the untoothed connection element, it is possible by means of the construction according to the invention to provide securement bores parallel to the axis of rotation of the arrangement, so that the mechanical production and in particular the automatic tightening of the securement bolts can be facilitated still further.

In order to achieve the second part of the combined objective the invention envisages the provision of bodies with bores for the passage of the securement bolts, which bodies can be inserted in a matching manner into, in each case, two sunk depressions corresponding to one another of the untoothed connection element and of the housing part to be fixed thereto. These bodies can transmit the axial compression forces from the securement bolts to the annular housing part.

If the passage openings for the inserted bodies have on the upper side widened sections to sink the securement bolts, the said securement bolts can be completely integrated despite the use of additional insertion bodies, so that the overall height of the rotating connection remains a minimum. In order to enable a complete sinking of the bolt heads, the height of the insertion bodies and thus also the depth of the sunk cavities must be made larger than the height of a bolt head.

The annular housing part should be dimensioned so that it extends along the front end of the toothed connection element and the toothing arranged thereon, or beyond the latter. The periphery of this housing part is then continued by a cylindrical housing part in the form of a casing, which is preferably welded on but may also be bonded, bolted on or secured in any other suitable way or may be manufactured in one piece with the former. This cylindrical housing part in the form of a casing thus covers the whole toothing so that only a narrow gap still remains between the toothed connection element and the cylindrical, casing-shaped housing part facing the latter. Thus, also in this remaining gap no dirt or other particles can penetrate the region of the toothing, with the result that the toothing is enclosed by the housing in a dust-tight manner should the housing part extending over the toothing be sealed with respect to the toothed connection part on its front end facing the first, annular housing part. This seal may be secured either to the housing part covering the toothing or to the toothed connection element and may extend along the in each case other element. In order that this sealing element does not hinder the rotational movement of the toothed connection element, the toothing should not be extended completely up to its front end containing the connection bores, but should terminate and be set back in the axial direction relative to the connection side of the toothed connection element by an amount roughly corresponding to the thickness of the sealing material.

In order completely to exclude the potentially damaging effects of penetrating foreign bodies, a (second) seal may be provided that is located on the side of the guideway for the rolling bearing(s) opposite the first housing part. The toothed connection element is thus tightly enclosed on three sides between the guideway of the untoothed connection element, the two housing parts and the two seals, and in normal operation no dirt particles at all can penetrate either the region of the rolling bearing or the toothed region, with the result that the wear of these parts is significantly reduced and thus the service life of the rotating connection according to the invention can be extended.

It has proved convenient if the seals are formed as elastic sealing rings and are secured by an edge in or on a connection element, for example by insertion in a radially running groove and/or by bonding, and are pressed against a surface of the in each case other connection element. On account of the rotational symmetry of the two connection elements the seal is not deformed at all during a relative rotation of the elements, but always remains in the same position and thus does not exhibit any fatigue phenomena. In addition the compression forces of the sealing rings are very slight and therefore generate scarcely any frictional forces, and since moreover the rotational speeds of such rotating connections are generally relatively low, the sealing rings exhibit scarcely any abrasion phenomena despite the fact that they come into contact with a moving body.

The invention furthermore provides the possibility that the gear element, or gear elements in the case of several drive motors, that mesh with the toothed connection element, in particular pinions or worms, is/are surrounded by an optionally radially expanded part of the housing. As a result of the toothed engagement of the gear part with the toothed connection element coupled to the rotor of the drive motor, a complete encapsulation of the latter is possible only if the relevant gear part is likewise enclosed. The radial expansion of the housing produced thereby causes local deformations of the two housing parts compared to the ideal annular or cylindrical casing-shaped form, which however can be overcome with moderate extra effort by using modern fabrication methods.

Finally, corresponding to the teaching of the invention the drive motor can be fixed, in particular bolted onto the untoothed connection element and/or onto a housing part connected thereto. Since each torque transmitted by a drive motor via a pinion or a worm is accompanied according to Isaac Newton's law: “action and reaction are equal and opposite” by a moment attempting to rotate the motor housing in the opposite direction, the motor housing must be fastened to the non-driven connection element or to a machine part coupled to the latter, in particular must be fixed to the housing according to the invention. If in this connection the motor is fixed by means of bolts, it can if necessary be quickly replaced in the event of malfunction.

Further features, details, advantages and effects based on the invention will be seen from the following description of some preferred embodiments of the invention, with the aid of the drawings, in which:

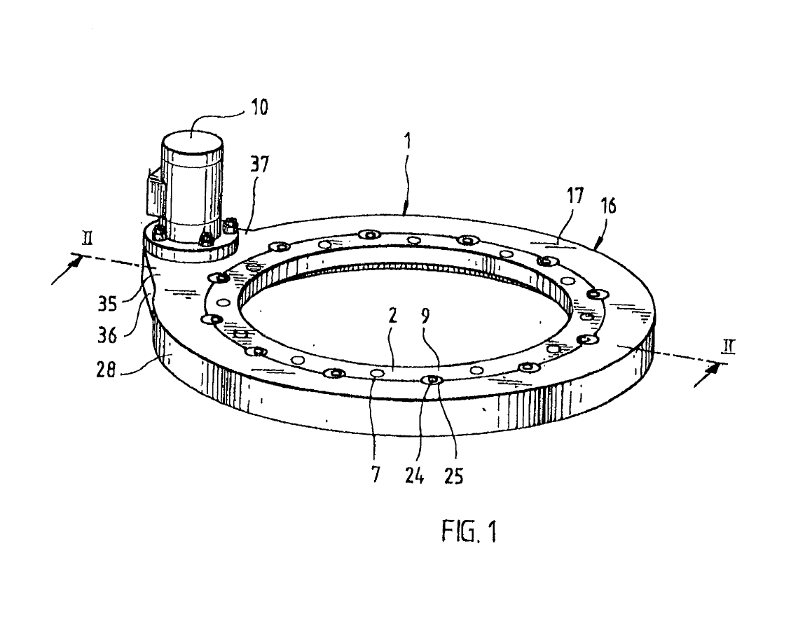

FIG. 1 is a perspective view of a first embodiment of the invention;

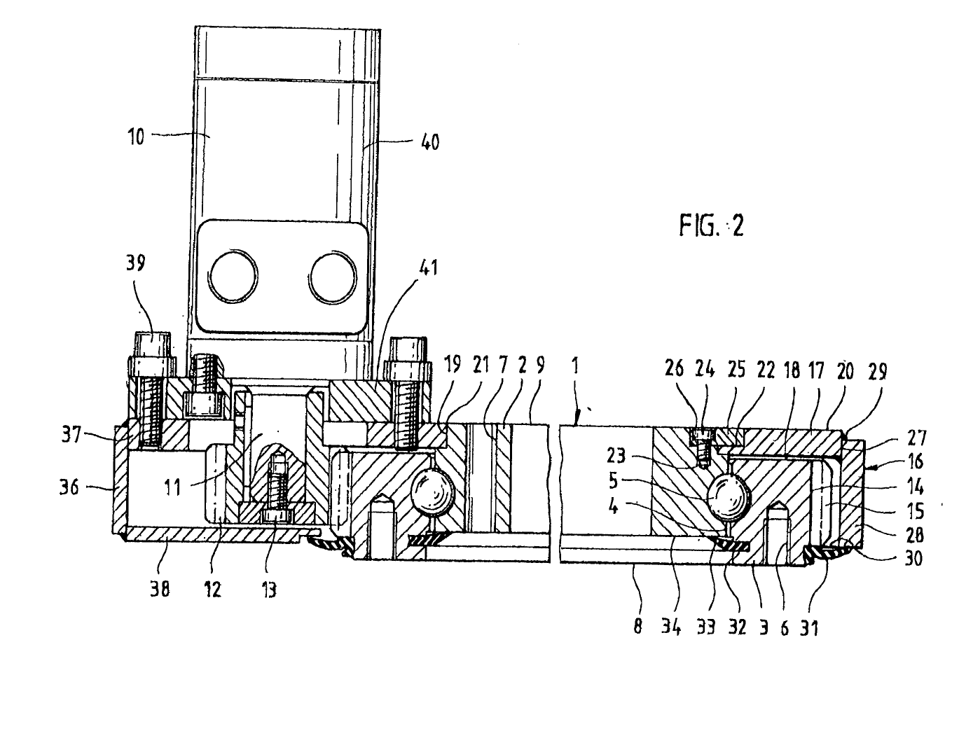

FIG. 2 is a section through FIG. 1 along the line II-II;

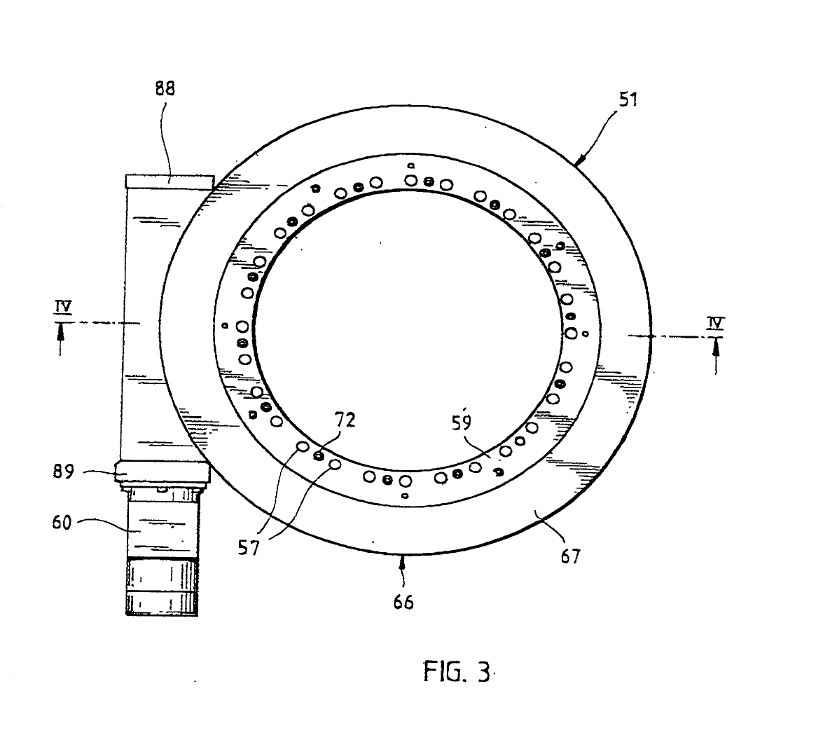

FIG. 3 is a plan view of a second embodiment of the invention, and

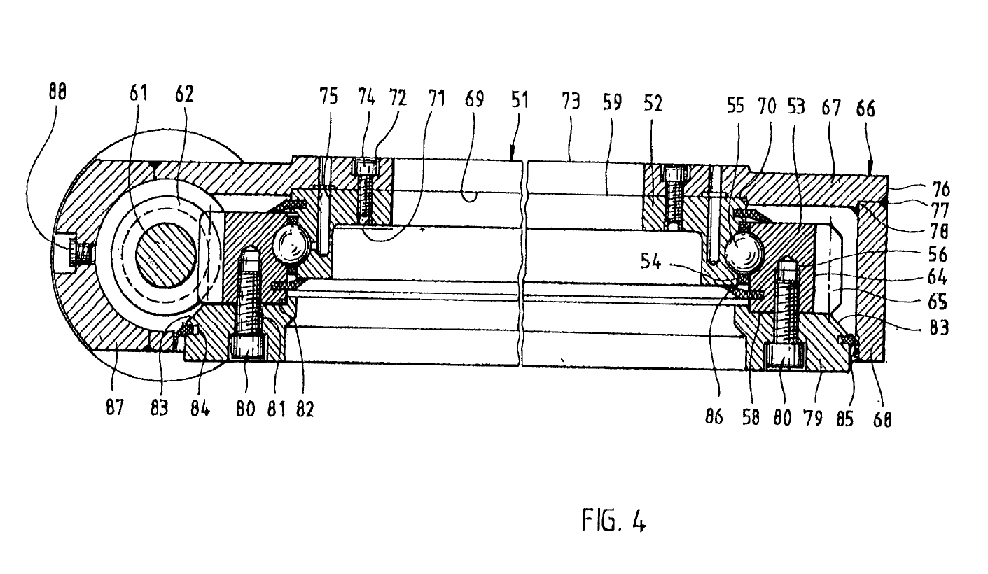

FIG. 4 is a section through FIG. 3 along the line III-III.

The rotating connection 1 according to FIGS. 1 and 2 has the advantage of a particularly low overall height in the region of the two connection elements 2, 3 arranged coaxially with one another. As can be seen from FIG. 2, the two connection elements 2, 3 have an annular shape of roughly rectangular cross-section, the external diameter of the inner connection element 2 being slightly less than the internal diameter of the outer connection element 3, so that in the region of this joining site 4 an easily achievable relative rotatability between the two connection elements 2, 3 can be ensured with a single-row ball-bearing race 5, while at the same time axial and radial forces and tilting moments can be absorbed.

On the lower side 8 of the outer connection element 3 shown in FIG. 2, a plurality of threaded blind holes 6 parallel to the axis of rotation are arranged distributed around the axis of rotation in the form of a crown for securement by bolts to a machine part. The innerlying connection element 2 also has a row of passage bores 7 likewise arranged around the axis of rotation in the form of a crown for accommodating securement bolts for a second machine part that is to rotate relative to the first part. So that the connections element 2, 3 firmly bolted to the respective other part does not come into contact with the latter during the relative rotation of the two machine parts, both connection elements 2, 3 are displaced in the axial direction relative to one another so that the respective connection surfaces 8, 9 are displaced outwardly, i.e. upwardly or downwardly, relative to the in each case other connection element 3, 2.

For the rotational drive of the outer connection element 3 relative to the inner connection element 2, a drive motor 10 with a drive shaft 11 parallel to the axis of rotation of the rotating connection 1 is arranged radially outside the two connection elements 2, 3, a pinion 12 being secured, for example firmly bolted 13, to the said shaft. This pinion 12 meshes with a toothing 15 surrounding the outer circumference 14 of the outer connection element 3 and thereby causes the connection element 3 to rotate, since the drive motor 10 is coupled on the housing side to the innerlying connection element 2.

In order to protect the toothing 15 of the outer connection element 3, the said toothing is surrounded by a housing 16 that is joined to the untoothed connection element 2. For this purpose a first housing part 17 is provided in the frame of the housing 16, which housing part is of circular shape and has a radial width that is slightly larger than the radial width of the outer connection element 3 together with its outer toothing 15. The thickness of this annular disc 17 is somewhat less than the axial mismatch of the connection surface 9 of the inner connection element 2 with respect to the relevant front end 18 of the toothed connection element 3.

The outer boundary edge of the connection surface 9 of the untoothed connection element 2 is provided with a rectangular channel 19 whose axial extension is equal to the thickness of the annular housing part 17, while its radial extension is dimensioned so that the outer circumference measured therein of the untoothed connection element 2 is largely identical or slightly less than the internal diameter of the annular housing part 17. In this way it is possible to insert this housing part 17 into the channel 19 for the purposes of centring, the outside 20 of the housing part 17 being aligned with the connection surface 9 of the untoothed connection element 2 or being set back in the axial direction.

In order to fix this position of the annular housing part 17 relative to the untoothed connection element 2, depressions 22 arranged roughly equidistantly from one another are provided in the region of the joint gap 21 over the circumference of the connection element 2, the said depressions being for example circular in shape. These depressions 22 extend roughly halfway in the peripheral region of the connection surface 9 of the untoothed connection element 2 and into the adjoining region of the front end 20 of the housing part 17 flush therewith. Furthermore, threaded/blind holes 23 parallel to the axis of rotation are provided within the part of the depressions 22 incorporated into the connection element 2, into each of which holes a machinery bolt 24 can be screwed.

Before insertion of these machinery bolts 24 a metal washer 25 is however first of all inserted in each depression 22, the basic shape of the washer corresponding as regards thickness and area to that of a depression 22. A stepped passage bore 26 is provided in each of the insertion bodies 25, which bores can be brought into alignment with the threaded/blind hole bore 23 by appropriate rotation of the insertion body 25 within the depression 22, so that the machinery bolt 24 can be screwed through this recess into the bore 23 of the untoothed connection element 2 until the head of the machinery bolt 26 within the radially expanded region above the stepped arrangement is sunk in the insertion body 25, and the lower side of the bolt head presses against the shoulder of the stepped arrangement and thereby fixes the washer-shaped insertion body 25. Since this at the same time projects into the depression region 22 of the housing part 17, it is thereby fastened non-detachably in the axial direction on the untoothed connection element 3, as well as in a non-rotatable manner in the azimuthal direction on the untoothed connection element 2. For this purpose it is important that the depth of the depression 22 is less than the thickness of the annular housing part 17, but greater than the thickness of the head of the machinery bolt 24.

A cylindrical, casing-shaped housing part 28 is securely welded 29 to the peripheral front end 27 of the annular housing part 17. The extension of this cylindrical casing-shaped housing part 28 parallel to the axis of rotation of the rotational connection 1 corresponds roughly to the height of the toothed region and to the thickness of the annular housing part 17.

The remaining gap 30 between the cylindrical casing-shaped housing part 28 and the outer circumference 14 of the toothed connection element 3 is closed by a sealing ring 31, which is secured for example to the outer casing surface 14 of the toothed connection element 3 beneath its toothed region 15 and extends radially outwardly to below the cylindrical casing-shaped housing part 28 and is compressed by the inherent elasticity of the sealing ring 31 against this housing part 28. In a similar manner a sealing ring 33 may be provided on the internal circumference 32 of the toothed connection element 3, which covers the joint gap 4 underneath the ball-bearing race 5 and is pressed against the lower front end 34 of the untoothed connection element 2.

The housing 16 may be radially broadened 35 in the region of the motor 10, the said broadening being formed by a bulge 36 of the cylindrical casing-shaped housing part 28 and a radial continuation 37 of the annular housing part 17, and if necessary may be sealed on the front end opposite the motor 10 by a plate 38 whose area roughly corresponds to that of the continuation part 37. This widening of the housing 35-38 surrounds the drive pinion 12 and at the same time creates a stable connection surface 37 for the bolting-on 39 of the motor housing 40. For stiffening purposes and/or to facilitate the securement, a further metal plate 41 may be provided between the securement surface 37 and the motor housing 40.

Also several drive motors 10 can be coupled to the rotating connection 1, several housing widenings 35 can be arranged on its circumference, preferably displaced by the same rotational angle relative to one another. If the housing widenings 35 are not utilised, the opening for the insertion of the pinion 12 can be closed by a bolted-on cover 39.

As can be seen from FIG. 3, a further embodiment 51 of a rotating connection according to the invention differs externally from the first embodiment in particular by the fact that the drive motor 60 is mounted not parallel to the axis of rotation but instead tangentially to the outer connection element 53. From FIG. 4 it can be seen that a worm 62 instead of a pinion is arranged on the drive shaft 61 of the drive motor 60, which meshes with the toothing 65 arranged on the outer circumference 64 of the radially outerlying connection element 53.

As can furthermore be seen from FIG. 4, the basic structure of the rotating connection 51 is rather similar to the rotating connection 1 of FIGS. 1 and 2. The two connection elements 52, 53 are arranged coaxially to one another and are in each case displaced outwardly with respect to the in each case other element 52, 53, by a small amount in the direction of their connection surfaces 58, 59. In this embodiment 51 a single-row ball-bearing race 55 is also provided at the joining site 54.

For the securement of a rotatable plant or machinery part, threaded/blind holes 56 parallel to the axis of rotation are provided in the connection surface 58 of the toothed connection element 53, while the corresponding connection bores 57 in the connection surface 59 of the inner connection element 52 are formed as continuous bores. In this embodiment too the securement bores 56 of the toothed connection element 53 are accordingly located between its toothing 65 and the ball-bearing race 55, in order to obtain an arrangement having minimal dimensions.

Moreover, in this embodiment also a housing 66 is provided consisting of two parts 67, 68. An annular housing part 67 has a radial width extension that is somewhat larger than the difference between the external radius of the toothing 65 and the internal radius of the untoothed connection element 52. A stepped arrangement is provided in the underside 69 of the annular housing part 67 at a distance from the axis of rotation corresponding to the outer circumference of the untoothed connection element 52, so as to form a channel 70 viewed from the centre of the annulus 67, in which channel the outer edge of the connection surface 59 of the untoothed connection element 52 can engage in a centring manner. In order to fix the annular housing part 67 completely to the untoothed connection element 52, threaded bores 71 are arranged for example between the through bores 57 of the connection element 52, with which threaded bores corresponding bores 72 in the annular housing part 67 can be aligned by appropriate rotation. The bores 72 of this housing part 67 have no internal threads and instead have a cross-sectional broadening in the region of the outside 73 of this housing part 67 that can accommodate the head of a securement bolt 74.

The through bores 57 of the untoothed connection element 52 as well as also lubrication channels 75 arranged therein for the ball-bearing race 55 extend in the housing part 67 up to the outside 73 of the latter. When securing a plant or machinery part to the untoothed connection element 52, the frictional connection by means of bolts passing through and engaging behind its through bores 57 acts directly on the part. The interposed housing rings 67, 79 accordingly have no independent supporting function in the sense of transmitting an axial force and tilting moment, but instead simply assist the torque of the drive motor 40.

A cylindrical casing-shaped housing part 68 is welded 77 onto the outer circumference 76 of the annular housing part 67. The cylindrical casing-shaped housing part 68 coincides as regards its external diameter to the external diameter of the annular housing part 67 and can be centred on a channel 78 incorporated externally 76 into its lower side. The internal diameter of the cylindrical casing-shaped housing part 68 surrounds the toothing 65 and is spaced therefrom, and extends to beyond the toothing region 65 that terminates at the connection surface 58 of the connection element 53.

In order to be able to effect a seal underneath this toothing 65 in this embodiment 51 despite the widely set-back toothing 65, a metal ring 79 of the same diameter is firmly bolted 80 to the connection surface 58 of the toothed connection element 53. For this purpose bores 81 coincident with the threaded/blind holes of the toothed connection element 53 are provided in the metal ring 79, the bores being widened on the underneath in order to accommodate the head of the machinery bolts 80. By means of a channel 82 arranged in the region of the internal circumference of the metal ring 79, a centring of this metal ring 79 on the innerlying edge of the connection surface 58 of the toothed connection element 53 can be achieved.

The outer circumference of the metal ring 79 is provided in the region of the toothing 65 with a bevelled surface 83 running roughly tangentially to the circumference of the worm 62 in order to prevent contact with the said worm 62. A sealing ring 85 inserted in a circumferentially running groove 84 is arranged underneath this bevelled region 83, the outer circumference of the sealing ring pressing against the inside of the cylindrical casing-shaped housing part 68 and thereby producing a seal. Further seals 86 are provided on both sides of the joining site 54 accommodating the ball-bearing race 55 between the two connection element 52, 53.

The housing part 68 is discontinued in the region of the worm 62, and the gap produced by the toothing engagement between the worm 62 and tooth crown 65 is closed by a roughly cylindrical housing part 87 that surrounds the worm 62. The housing part 87 has only a roughly semicircular shape in the central region of the toothing engagement, whereas on the peripheral ends 88, 89 where the worm 62 is mounted and/or where the drive motor 60 is flanged-on, the cross-section of the housing part 87 roughly corresponds to a complete circle. A lubricant 88 may be provided in the housing part 87, in particular in the region opposite the toothing engagement. Several, in particular two drive motors 60 and worms 62 as well as housing parts 87 surrounding the latter may also be provided in order to increase the drive torque.

What is claimed is:

1. Device (1, 51) for the rotatable coupling of two coaxial connection elements (2, 3; 52, 53), comprising a rotating bearing formed as a single-row or multi-row rolling bearing (5, 55) between the connection elements (2, 3; 52, 53) for accommodating axial and radial loads and tilting moments, as well as a drive (10, 60) coupled or that may be coupled to both connection elements (2, 3; 52, 53) to effect relative rotation thereof, the frame of the drive being secured to a first connection element (2, 52), while its rotor is connected to a pinion (12) or a worm (62), which pinion or worm mesh with a casing-side toothing (15, 65) of the second connection element (3, 53), wherein securement means (6, 56) arranged in the form of a crown in a front end of the toothed connection element (3, 53) are provided for the securement of this connection element (3, 53) to a first machine part, the said securement means (6, 56) being arranged between the toothing (15, 65) and the rotating bearing (5, 55), characterised in that the toothing (15, 65) of the second connection element (3, 53) is enclosed by at least one housing part (16, 66) that is fixed to the untoothed connection element (2, 52) and surrounds the toothed connection element (3, 53) at the front end (18) opposite its connection/securement means (6, 56), and that the securement means (7, 57) for securing the untoothed connection element (2, 52) to a second machine part are arranged on the untoothed connection element (2, 52) itself, so that a direct frictional connection is produced between the machine part and the untoothed connection element by securement means (bolts, etc.) (7, 57), even if there are still housing parts (17, 66) between the machine part and the untoothed connection element (2, 52).

2. Device according to claim 1, characterised in that the toothing (15, 65) and the guideway for the ball-bearing race (5, 55) of the second connection element (3, 53) is formed by machining or shaping the said connection element/base member.

3. Device according to claim 1, characterised in that one or both connection elements (2, 3; 52, 53) are formed as concentric rings or washers and the securement means are formed as bores (6, 7; 56, 57) arranged in the form of a crown.

4. Device according to claim 1, characterised in that the toothed connection element (3, 53) is formed as an internally or externally toothed crown.

5. Device according to claim 4, characterised in that the ball-bearing race/guideway of the toothed connection element (3, 53) is arranged on its casing surface opposite the toothing (15, 65).

6. Device according to claim 5, characterised in that the radial distance of the securement bores (6, 56) of the toothed connection element (3, 53) to the base of the ball-bearing race/guideway of the toothed connection element (3, 53) corresponds roughly to the radial distance of these bores (6, 56) from the base of the toothing (15, 65).

7. Device according to claim 1, characterised in that the securement bores (6, 56) in the toothed connection element (3, 53) are provided with an internal thread.

8. Device according to claim 1, characterised in that the securement bores (6, 56) of the toothed connection element (3, 53) are formed as blind holes open exclusively to its connection/front end, the depth of the bores being between ½ and ¾ the overall height of the toothed connection element (3, 53).

9. Device according to claim 5, characterised in that the floor of the securement bores (6, 56) of the toothed connection element (3, 53) is located roughly at the height of the greatest convexity or tapering of the toothed connection element (3, 53) as a result of the incorporated guideway for the ball-bearing race (5, 55).

10. Device according to claim 1, characterised in that the housing part (16, 66) secured to the untoothed connection element (2, 52) extends in the form of an annulus (17, 67) along a front end (18) of the toothed connection element (3, 53) and parallel to the latter.
